(19) United States
(12) Patent Application Publication
(10) Pub. No.: US 2012/0039653 A1
(43) Pub. Date: Feb. 16, 2012

(54) Substance Applicator

(75) Inventor: Jeffrey H. Fischer, Warminster, PA (US)

(73) Assignee: Clarence J. Venne, LLC, Bristol, PA (US)

(21) Appl. No.: 13/208,489

(22) Filed: Aug. 12, 2011

Related U.S. Application Data
(60) Provisional application No. 61/373,613, filed on Aug. 13, 2010.

(51) Int. Cl. B05C 17/00; B05C 21/00; B65B 43/00

(52) U.S. Cl. 401/6; 401/292; 53/452

(57) ABSTRACT

An applicator includes a hollow body having a central longitudinal axis to hold a colored ink, a shoulder portion, a central recessed portion, and a base portion. The shoulder portion is located above and merges with the central recessed portion at an upper end thereof and includes a top wall having an opening. The base portion is located below and merges with the central recessed portion at a lower end thereof and includes a bottom wall. The central recessed portion has a smooth continuous sidewall formed as a triangle with three sides of substantially identical dimensions. The central recessed portion merges with the shoulder portion and the base portion at upper and lower flared surfaces, respectively.

### CROSS-REFERENCE

This application claims the benefit of U.S. Provisional Patent Application No. 61/373,613 file on Aug. 13, 2011, which is incorporated herein in its entirety.

### BACKGROUND OF THE INVENTION

This invention relates generally to substance applicators or markers and particularly to substance applicators for planar surfaces or items requiring the application of a mark or coating.

Various applicators for marking surfaces currently exist, including applicators that are sold by the assignee of the subject invention, Clarence J. Venne, Inc., as shown in U.S. Design Pat. Nos. D274,697, D300,118, D303,926, D396,244, D389,365 and D138,621 and U.S. Pat. Nos. 5,713,681 and 6,913,405. While many prior art substance applicators, including those of the assignee of this invention, were suitable for their intended purposes, a need still remains to improve the comfort and ergonomic grip of applicators that may be disposed in any one of a number of differing rotational positions.

For example, although some prior art applicators were designed with comfort in mind, they required users to position the applicator in a specific rotational positions. One example of such a design is shown in Design Pat. No. D455,782. Another example is shown in U.S. Pat. No. 6,095,705. Both of these designs require the user to hold the applicator in a specific rotational position.

### SUMMARY OF THE INVENTION

The present invention is directed to an applicator that includes a hollow body having a central longitudinal axis to hold a colored ink, a shoulder portion, a central recessed portion, and a base portion. The shoulder portion is located above and merges with the central recessed portion at an upper end thereof and includes a top wall having an opening. The base portion is located below and merges with the central recessed portion at a lower end thereof and includes a bottom wall. The central recessed portion has a smooth continuous sidewall formed as a triangle with three sides of substantially identical dimensions. The central recessed portion merges with the shoulder portion and the base portion at upper and lower flared surfaces, respectively.

A better understanding of the objects, advantages, features, properties and relationships of the invention will be obtained from the following detailed description and accompanying drawings which set forth illustrative embodiments that are indicative of the various ways in which the principles of the invention may be employed.

### BRIEF DESCRIPTION OF THE DRAWINGS

For a better understanding of the invention, reference may be had to preferred embodiments shown in the following drawings in which:

FIG. 1 is a perspective view of a substance applicator in accordance with the present invention;

FIG. 2 is a side elevational view of the applicator of FIG. 1;

FIG. 3 is a back elevational view of the application of FIG. 1;

FIG. 4 is a front elevational view of the applicator of FIG. 1;

FIG. 5 is a bottom plan view of the applicator of FIG. 1; and

FIG. 6 is a top plan view of the applicator of FIG. 1.

### DETAILED DESCRIPTION

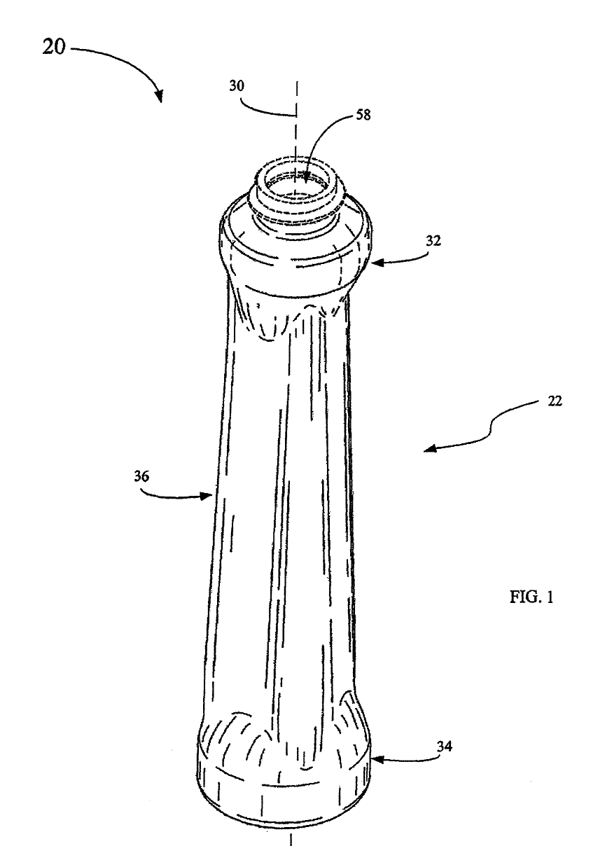

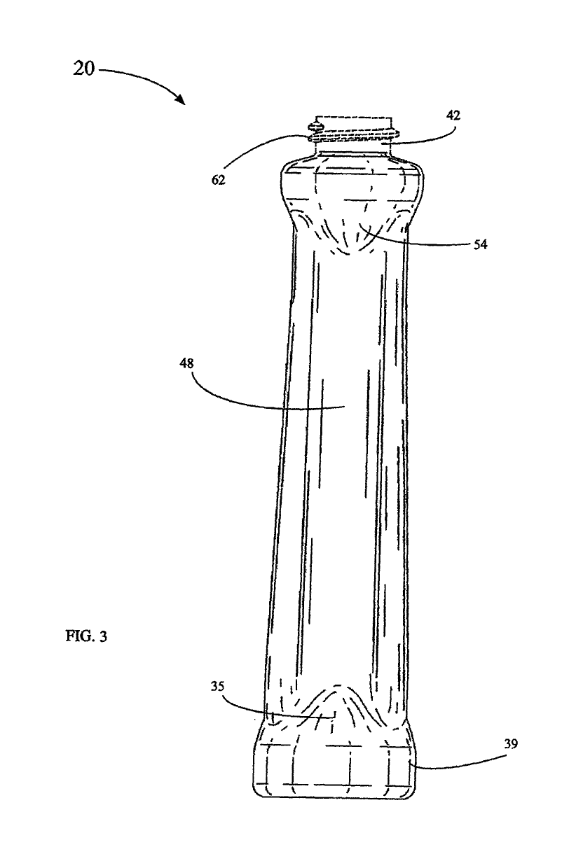

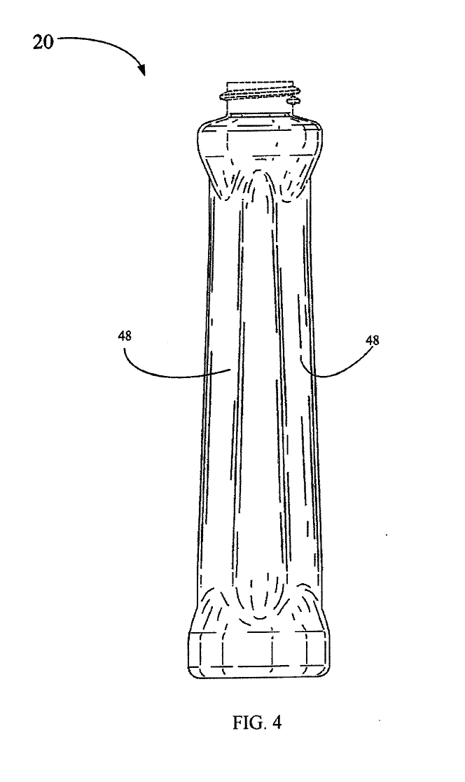

While several embodiments of the present invention are shown in the drawings and described in detail, the present disclosure should be considered as an exemplification of the principles of the invention and is not intended to limit the invention to the embodiments so illustrated. The invention will be illustrated in more detail with reference to the following example, but it should be understood that the Referring now to various figures of the drawings where like reference numerals refer to like parts, there is shown a substance applicator constructed in accordance with the subject invention. As shown in FIGS. 1-4, the substance applicator 20 can be a bottle or other container adapted to contain a substance in the interior thereof for the application of the substance to a surface under the control of a user. The substance contained within the substance applicator 20 for application to the surface may be an ink, for example, for applying the ink to a surface such as the surface of a bingo card or other type of game card. Additionally, the substance contained within the substance applicator 20 may be a shampoo, a dye, a conditioner or any other hair products, or substances for use in connection with arts and crafts, such as glue. The substance contained within the applicator 20 may also be a paint or inking substance such as a window paint, poster paint, bathtub paint, blackboard paint or various types of children's' paints, varnishes and other coatings. Furthermore, materials for use in an office environment, shoe polish, soap, cosmetics, nail polish, sealing agents, medicaments, or any substance suitable for applying the substance to a surface as described herein may also be contained within the substance applicator 20.

As best seen in FIGS. 1 and 6, the substance applicator 20 basically comprises a hollow body 22 having an opening 58 at the top thereof and may include threads 62 for receiving and securing a cap (not shown) and an applicator substance transferring device (not shown). The cap for the substance applicator 20 may be of any suitable shape in the interest of aesthetics, as long as it includes interior threads for mating with the threads 62 of the applicator 20.

The structural details of the body 22 will be described later. Suffice it to state that the body 22 of the substance applicator 20 includes a large hollow interior space or cavity for receipt of the substance therein as previously described. The substance transferring device may be of a conventional type that is used for the particular substance disposed within the applicator 20. The substance transferring device may be inserted into the opening 58 at the top of the applicator 20. Preferably, the substance transferring device inserted therein constitutes a spring valve device or other easy-flow device, similar to the device described in U.S. Pat. No. 6,913,405, which is hereby incorporated in its entirety by reference.

The substance within the interior of the applicator 20 is placed in communication with the substance transferring device when the applicator 20 is inverted, so that when the applicator 20 with the cap removed is inverted and brought into forcible engagement with a surface (not shown) or other item to be marked, the substance transferring device applies a mark to the surface or item. The mark can be circular or any other shape, depending on the substance within the applicator 20 and the shape of the substance transferring device. For example, relatively smaller markings may be applied if the substance is eye makeup or another cosmetic. The substance applicator 20 is arranged to be held in the crook formed between the thumb and index finger of a hand, with the thumb, index finger and middle finger of the hand resting on portions of the applicator 20, so that the applicator 20 can be inverted and manipulated like a pencil, pen, or other writing instrument.

When the applicator 20 is no longer needed to mark a surface, the cap may be threadibly received by the threads 62, thereby sealing off the substance transferring device from the ambient air, and preventing the substance from drying out and/or allowing the substance in the cavity of the body 22 to leak, harden or evaporate.

The body 22 of the substance applicator 20 is formed of a suitable plastic material, which is preferably blow molded by extrusion of injection, so that it is a unitary member of substantially uniform wall thickness. As can be seen clearly in FIGS. 1-4, the body 22 of the substance applicator 20 is an elongated member having a central longitudinal axis 30 extending therethrough. The body 22 includes a shoulder portion 32, a base portion 34 and a central recessed portion 36.

The shoulder portion 32 includes a cylindrically circular sidewall 38 extending around the central longitudinal axis 30, and having a predetermined exterior diameter (e.g., approximately 1.665 inch (42.29 mm), measured perpendicular to the central axis 30, a slightly concave frustoconical intermediate sidewall 40 extending up from the circular sidewall 38, and a generally planar top wall 42. It will be understood that the applicator 20 can be adapted to contain varying amounts of substance, i.e., four ounces, and that the dimensions of the applicator 20 can be adjusted accordingly, as shown in more detail below, without departing from the spirit and scope of the invention.

The top wall 42 of the applicator 20 includes an open circular neck centered about the central longitudinal axis 30. The helical thread 62 extends about the open circular neck. The substance transfer device can be mounted on the top of the neck centered around the central longitudinal axis 30 in a conventional manner.

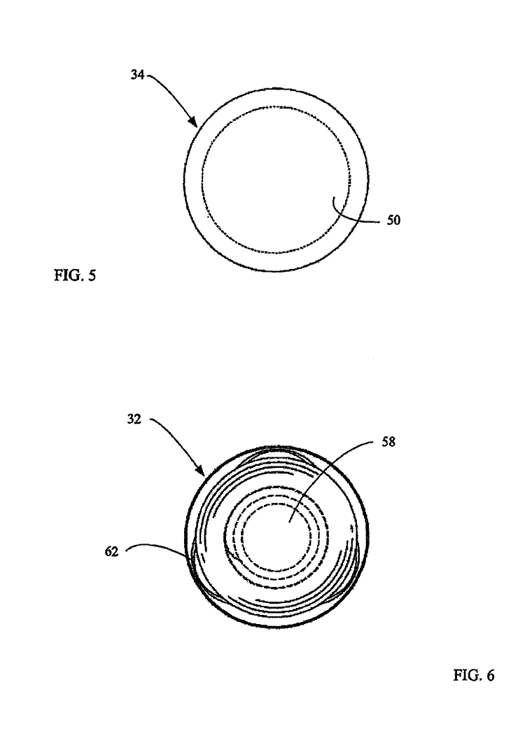

The base portion 34 of the applicator 20 includes a cylindrically circular sidewall 39 extending around the axis 30 and having substantially the same predetermined exterior diameter as the shoulder portion 32 measured perpendicular to the central axis 30. As best seen in FIG. 5, the base portion 34 of the applicator 20 also includes a generally planar bottom wall 50. The applicator 20 can be stored by disposing it on a support surface (not shown) with its planar bottom wall 50 in engagement therewith.

As will be appreciated by those skilled in the art, the fact that the shoulder portion 32 and the base portion 34 each include substantially similar circular sidewalls 38 and 39, respectively, having substantially the same outside diameter centered about the central longitudinal axis 30 enables the applicator 20 to be readily molded and removed from the molding machine. Moreover, the substance applicator 20 can be readily filled with substance during manufacturing regardless of its orientation within a filing machine.

The intermediate portion or central recessed portion 36 of the applicator 20 is constructed and sized and provided with a triangular shape to permit it to be ergonomically held within the crook between the thumb and index finger of one hand of the person holding the applicator 20 when the applicator 20 is either poised for use or inverted and put into use by applying it to a surface, regardless of which sides of the applicator 20 the user chooses to engage. For example, the applicator 20 can be held like a pencil or pen in a plurality of different rotational positions to mark the surface of a bingo card or other item. To that end the central recessed portion 36 is provided in the form of a substantially triangular sidewall. The triangular sidewall has three sides 48 of nearly identical dimensions. While the exact dimensions of the three sides 48 may vary without departing from the scope of this invention, the three sides 48 must be substantively identical and proportional to each other.

The triangular shape of the central recessed portion 36 allows users to grip the applicator 20 without the need for re-positioning the applicator based on how it is initially held. The triangular shape of the central recessed portion 36 may also be useful for providing three large viewing panels to which one or more labels may be affixed. The labels affixed to the applicator 20 may be conventional adhesive labels, shrink wrapped labels, or any other type of labels.

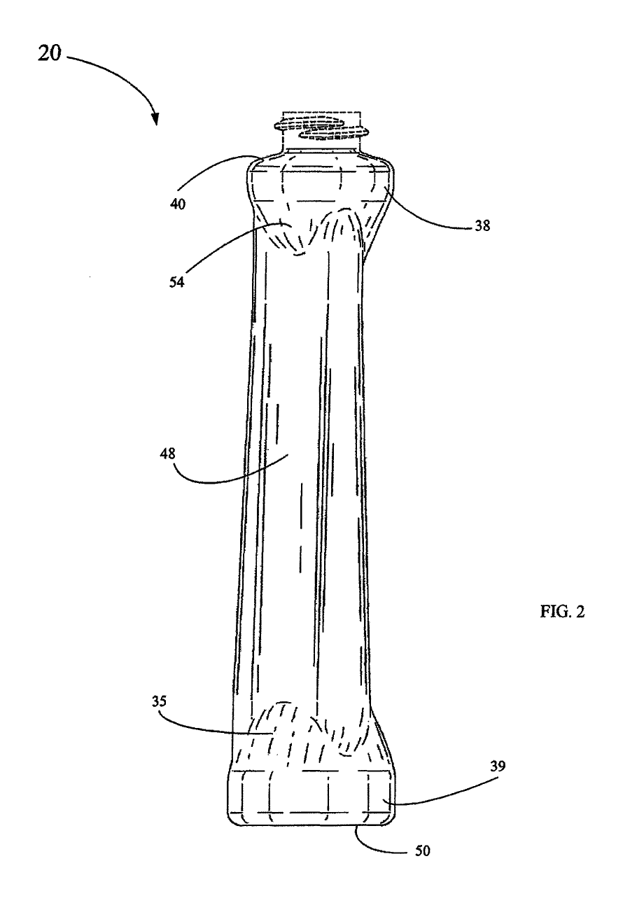

As best seen in FIGS. 1 and 2, the sidewalls of the central recessed portion 36 of the body 22 merge with the sidewall 38 of the shoulder portion 32 at three upper flared surfaces 54. The upper flared surfaces 54 of the applicator 20 are adapted to permit convenient mating of the substance applicator 20 with the hand of a person and ergometric use of the applicator 20 when the substance applicator 20 is picked up in a plurality of different rotational positions and gripped, both while it is poised and ready for use, and when it is inverted to apply force to a surface to be marked. The upper flared surfaces 54 may form concave arcuate surfaces for receiving the thumb and the index finger of a user.

In addition, as disclosed in U.S. Pat. No. 6,913,405 B2 assigned to the instant inventor and mentioned above, groups of ridges (not shown) can be provided on the three upper flared surfaces 54 of the central recessed portion 36 of the applicator 20 immediately below the shoulder 32, i.e., the upper flared portion of the recess. In one embodiment of the invention, there can be four ridges in each of the ridge groups. The ridges of each ridge group can be of graduated lengths that decrease in the direction from the lowermost of the ridges to the uppermost.

As shown in FIGS. 1-4, the sidewalls of the central recessed portion 36 of the body 22 may also merge with the sidewall 39 of the base portion 34 at three lower flared surfaces 35. The lower flared surfaces 35 may form concave arcuate surfaces.

The height of the applicator 20 may be any dimension desired depending on the amount of substance to be disposed therein. One particularly effective height to provide a capacity of approximately four ounces for ink or other substance is approximately 6.596 inches (167.5 mm) from the base wall 50 to the top of the opening in one embodiment. It will be understood that substance applicators 20 adapted to contain other amounts of substance for application to a surface can have differing dimensions, as previously described, including differing heights. Other sizes of applicator 20 are also contemplated within the scope of the invention without limiting the scope of the invention as set forth below. For example, in one alternative embodiment of the invention, adapted to contain approximately three ounces of substance for application to a surface, the outside diameter of the cylindrically circular sidewall 38 of the shoulder portion 32 extending around the central axis 30 may be approximately 1.540 inches (39.12 mm), and the height of the applicator 20 can be approximately 5.540 inches (140.17 mm). It will be understood that applicators 20 containing substantially more than four ounces of substance and substantially less than fifty milliliters of substance may also be provided.

In an additional alternate embodiment, the applicator 20 is adapted to contain approximately fifty milliliters of substance for application to a surface, the outside diameter of cylindrically circular sidewall 38 can be approximately 1.285 inches (32.64 mm). The height of the substance applicator 20 can be approximately 3.845 inches (97.66 mm). It will be understood that applicators 20 containing substantially more than four ounces of substance and substantially less than fifty milliliters of substance may be provided, including as little as approximately fifteen milliliters of substance. While specific embodiments of the invention have been described in detail, it will be appreciated by those skilled in the art that various modifications and alternatives to those details could be developed in light of the overall teachings of the disclosure. Accordingly, the particular arrangement disclosed is meant to be illustrative only and not limiting as to the scope of the invention which is to be given the full breadth of the appended claims and any equivalents thereof.

What is claimed is:

1. An applicator having a hollow body for storing and dispensing a substance, comprising:
a shoulder portion having a first diameter formed at the top portion of the hollow body;
a central recessed portion formed below the shoulder portion and having three sides of substantially identical dimensions; and
a base portion formed below the central recessed portion and having a second diameter,
wherein a width of the central recessed portion is less than the first diameter of the shoulder portion, the three sides of the central recessed portion merge with the shoulder portion at upper flared surfaces, and the three sides of the central recessed portion merge with the base portion at lower flared surfaces.

2. The applicator of claim 1, wherein the second diameter of the base portion is substantially equal to the first diameter of the shoulder portion.

3. The applicator of claim 2, wherein the first and second diameters are approximately 1.285 inches (32.64 mm).

4. The applicator of claim 1, wherein a height of the applicator is approximately 3.845 inches (97.66 mm).

5. The applicator of claim 1, wherein the upper flared surfaces have concave arcuate surfaces for receiving the thumb and index finger of a user.

6. The applicator of claim 1, wherein the lower flared surfaces have concave arcuate surfaces.

7. The applicator of claim 1, wherein the upper flared surfaces include a plurality of ridges for gripping by the thumb and index finger of a user.

8. The applicator of claim 2, wherein the first and second diameters are approximately 1.540 inches (39.12 mm).

9. The applicator of claim 1, wherein a height of the applicator is approximately 5.540 inches (140.17 mm).

10. The applicator of claim 1, wherein a height of the applicator is approximately 6.596 inches (167.5 mm).

11. A method of making an applicator having a hollow body for storing and dispensing a substance, the method including the steps of:
forming the applicator with a shoulder portion and a base portion each having circular side walls and a central recessed portion formed between the shoulder and base portions;
forming the central portion with three sides having substantially identical dimensions;
forming the circular side walls with diameters that are substantially the same and centered about a longitudinal axis of the applicator; and
filling the applicator while the applicator is disposed in any orientation,
wherein diameters of the circular sidewalls facilitate the molding and removal of the applicator.

12. The method of making an applicator of claim 11, further including the steps of forming the central recessed portion with a width that is less than a first diameter of the shoulder portion and merging the three sides of the central recessed portion with first flared surfaces that merge into the shoulder portion.

13. The method of making an applicator of claim 12, wherein the first flared surfaces have concave arcuate surfaces for receiving the thumb and index finger of a user.

14. The method of making an applicator of claim 13, further including the step of merging the three sides of the central recessed portion with second flared surfaces that merge into the base portion.

15. The applicator of claim 14, wherein the second flared surfaces have concave arcuate surfaces.

16. An applicator having a hollow body for storing and dispensing a substance, comprising:
a shoulder portion formed at a first end of the hollow body;
a base portion formed at a second end of the hollow body opposite the shoulder portion; and
a central recessed portion formed between the shoulder and base portions and having three sides of substantially identical dimensions,
wherein a width of the central recessed portion is less than a diameter of the shoulder portion and the three sides of the central recessed portion merge with the shoulder portion at flared surfaces that have concave arcuate surfaces.

17. The applicator of claim 16, wherein the flared surfaces include a plurality of ridges for gripping by the thumb and index finger of a user.

18. The applicator of claim 16, wherein the diameter is approximately 1.540 inches (39.12 mm).

19. The applicator of claim 16, wherein the base portion has a circular side wall with a diameter that is greater than the width of the central recessed portion.

20. The applicator of claim 16, wherein a height of the applicator is approximately 6.596 inches (167.5 mm).
